(19) United States
(12) Patent Application Publication
(10) Pub. No.: US 2004/0143932 A1
(43) Pub. Date: Jul. 29, 2004

(54) Prop connector

(76) Inventor: Kavin Chen, Taichung (TW)

Correspondence Address: KAVIN CHEN, 58, MA YUAN WEST ST., TAICHUNG, TW

(21) Appl. No.: 10/356,759

(22) Filed: Jan. 29, 2003

(51) Int. Cl. E05F 5/04

(52) U.S. Cl. 16/83

(57) ABSTRACT

A prop connector has a plurality of lobes. Each of the lobes has a through hole, an annular recess communicating with the through hole, and a lower periphery flange. The prop connector is disposed on an article such as a screen, a bookshelf, a partition, and a prop frame of a desk.

### BACKGROUND OF THE INVENTION

The present invention relates to a prop connector. More particularly, the present invention relates to a prop connector which is connected to two or more pivot props stably.

A conventional prop connector has a rotating disk, a plurality of balls inserted in the rotating disk, and and a cover engaging with the rotating disk. However, it is difficult to manufacture and assemble the rotating disk.

### SUMMARY OF THE INVENTION

An object of the present invention is to provide a prop connector which is connected to two or more pivot props stably.

Another object of the present invention is to provide a prop connector which has a simple structure to be assembled easily, quickly and conveniently.

Accordingly, a prop connector comprises a plurality of lobes. Each of the lobes has a through hole, an annular recess communicating with the through hole, and a lower periphery flange.

### BRIEF DESCRIPTION OF THE DRAWINGS

FIG. 1 is a perspective view of a prop connector of a first preferred embodiment in accordance with the present invention;

FIG. 1A is a perspective view of a prop connector of a second preferred embodiment in accordance with the present invention;

FIG. 1B is a perspective view of a prop connector of a third preferred embodiment in accordance with the present invention;

FIG. 2 is a perspective schematic view illustrating an application of a prop connector of a first preferred embodiment which is disposed on a bookshelf;

FIG. 3 is a perspective schematic view illustrating an application of a prop connector of a first preferred embodiment which is disposed on a screen;

FIG. 4 is a perspective schematic view illustrating an application of a prop connector of a first preferred embodiment which is disposed on a prop frame of a desk;

FIG. 5 is a perspective schematic view illustrating an application of a prop connector of a second preferred embodiment which is disposed on a first partition;

FIG. 6 is a perspective schematic view illustrating an application of a prop connector of a third preferred embodiment which is disposed on a first partition; and

FIG. 7 is a partially sectional view of a bookshelf.

### DETAILED DESCRIPTION OF THE INVENTION

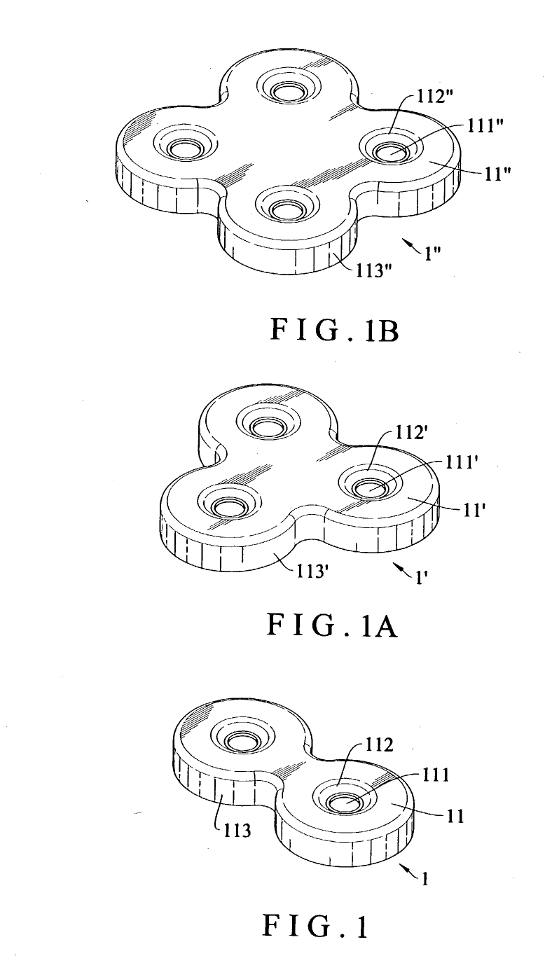

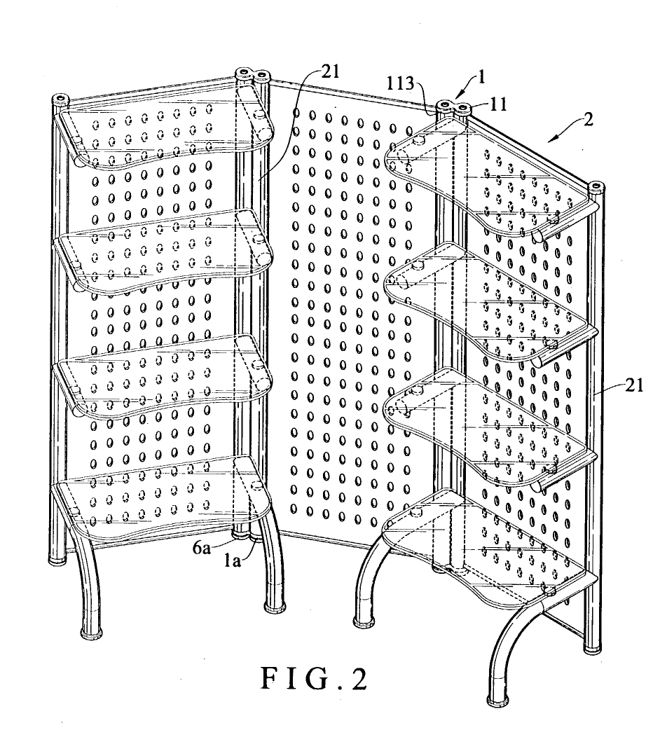

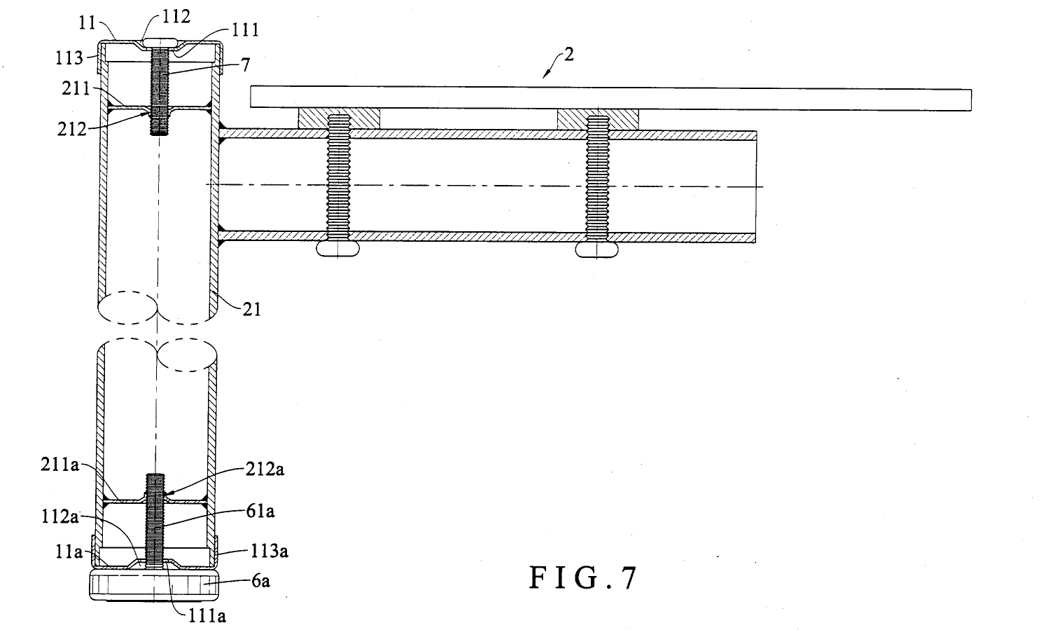

Referring to FIGS. 1, 2, and 7, a prop connector 1 comprises two lobes 11. Each lobe 11 has a through hole 111, an annular recess 112 communicating with the through hole 111, and a lower periphery flange 113.

A bookshelf 2 comprises a plurality of props 21. The prop connector 1 is disposed on a top of one of the props 21. Each prop 21 has an upper inner plate 211 having a threaded hole 212 and a lower inner plate 211a having a threaded aperture 212a. A fastening screw 7 passes through the through hole 111 of the corresponding lobe 11 and the threaded hole 212 of the upper inner plate 211.

An additional prop connector la is disposed on a bottom of one of the props 21. The additional prop connector la comprises two lobes 11a. Each lobe 11a has a through hole 111a, an annular recess 112a communicating with the through hole 111a, and a lower periphery flange 113a.

A pedestal pad 6a is disposed on a bottom of the additional prop connector 1a. The pedestal pad 6a has a threaded post 61a passing through the through hole 111a of the corresponding lobe 11a and the threaded aperture 212a of the lower inner plate 211a.

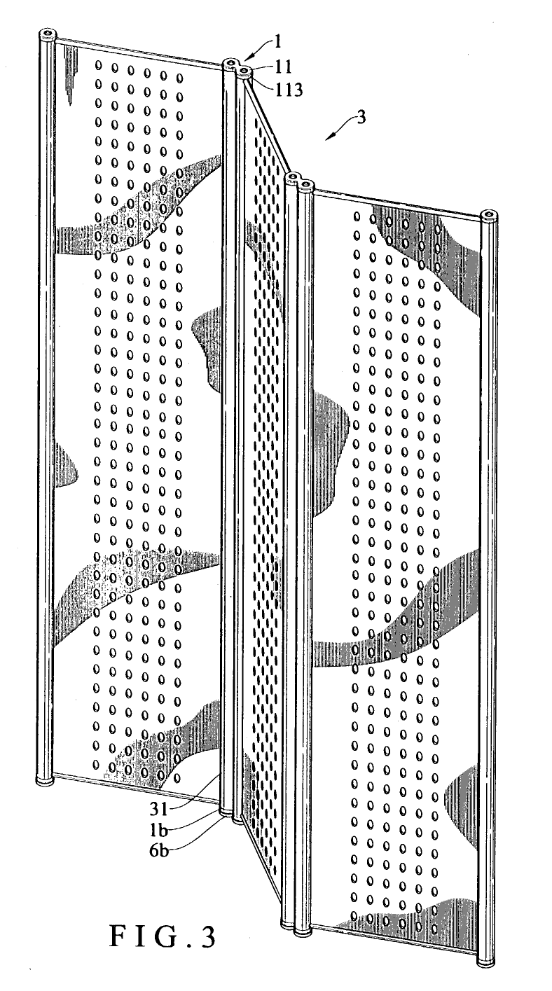

Referring to FIG. 3, the prop connector 1 is disposed on a top of a center prop 31 of a screen 3.

A further prop connector 1b is disposed on a bottom of the center prop 31 of the screen 3. A pedestal pad 6b is disposed on a bottom of the further prop connector 1b.

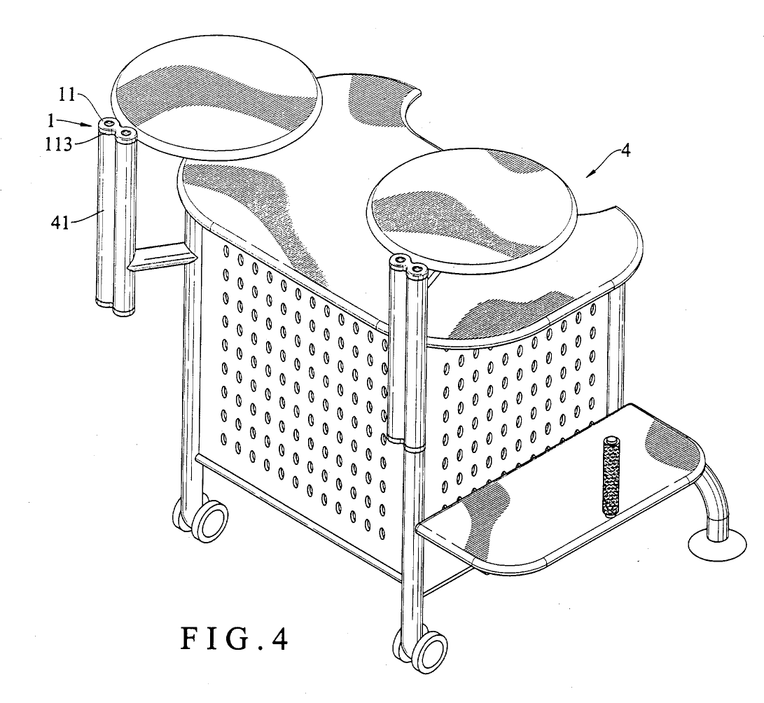

Referring to FIG. 4, a pair of prop frames 41 are connected to a desk 4. The prop connector 1 is disposed on a top of one of the prop frames 41.

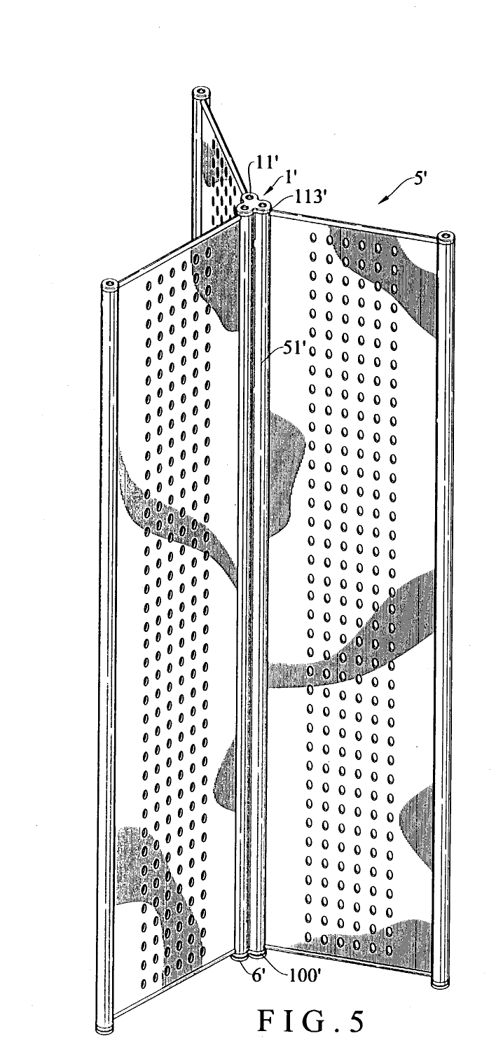

Referring to FIGS. 1A and 5, a second prop connector 1′ comprises three lobes 11′ to be disposed on a top of a center prop 51′ of a first partition 5′. Each lobe 11′ has a through hole 111′, an annular recess 112′ communicating with the through hole 111′, and a lower periphery flange 113′.

Another second prop connector 1′ is disposed on a bottom of the center prop 51′ of the first partition 5′ to be engaged with a pedestal pad 6′.

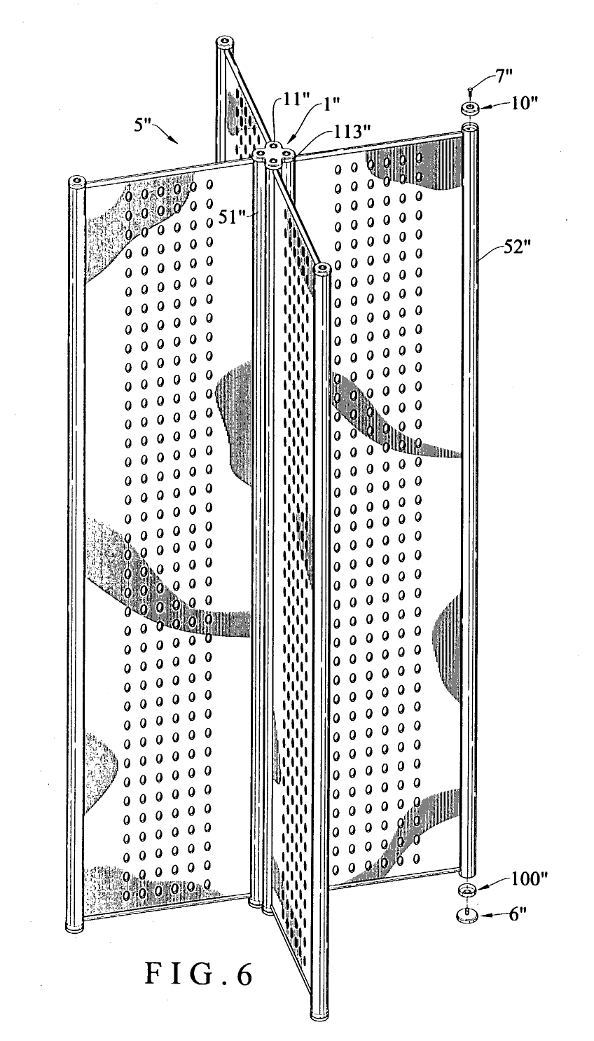

Referring to FIGS. 1B and 6, a third prop connector 1″ comprises three lobes 11″.

Each of the lobes 11″ has a through hole 111″, an annular recess 112″ communicating with the through hole 111″, and a lower periphery flange 113′.

The third prop connector 1″ is disposed on a top of a center prop 51″ of a second partition 5′.

A fourth prop connector 10″ is disposed on a top of a lateral prop 52″ of the second partition 5′.

A fifth prop connector 100″ is disposed on a top of the lateral prop 52″ of the second partition 5′.

A third pedestal pad 6″ is disposed on a bottom of the fifth prop connector 100″.

I claim:

1. A prop connector comprises:
a plurality of lobes,
each of the lobes having a through hole, an annular recess communicating with the through hole, and a lower periphery flange.

2. The prop connector as claimed in claim 1, wherein the prop connector has two said lobes.

3. The prop connector as claimed in claim 1, wherein the prop connector has three said lobes.

4. The prop connector as claimed in claim 1, wherein the prop connector has four said lobes.
